(19) United States
(12) Patent Application Publication
(10) Pub. No.: US 2020/0377211 A1
(43) Pub. Date: Dec. 3, 2020

(54) INDIVIDUALIZED AND CUSTOMIZED PLANT MANAGEMENT USING AUTONOMOUS SWARMING DRONES AND ARTIFICIAL INTELLIGENCE

(71) Applicant: BASF Agro Trademarks GmbH, Ludwigshafen (DE)

(72) Inventor: Mark Daddi, Moon Township, PA (US)

(21) Appl. No.: 16/755,271

(22) PCT Filed: Oct. 11, 2018
(86) PCT No.: PCT/US2018/055372

§ 371 Date: Apr. 10, 2020

Related U.S. Application Data
(60) Provisional application No. 62/572,311, filed on Oct. 13, 2017.

(51) Int. Cl. B64C 39/02; B64F 1/36; B64D 47/08; A01G 7/06; A01G 3/08; A01M 21/04; B64D 1/16; B64D 1/02; A01C 7/00; G06K 9/00

(52) U.S. Cl. CPC B64C 39/024; B64C 2201/18; B64D 47/08; A01G 7/06; A01G 3/085; A01M 21/046; B64D 1/16; B64D 1/02; A01C 7/00; G06K 9/00657; B64C 2201/126; B64C 2201/146; B64C 2201/145; B64C 2201/027; B64F 1/362

(57) ABSTRACT

The present disclosure generally relates to a system and method for providing individualized management for a plurality of plants. An exemplary system comprises a plurality of drones including a first drone, a docking station, and a server. The first drone is in assigned to a first plant of the plurality of plants and is configured to accommodate a plurality of combinations of drone attachments. The docking station comprises a plurality of drone attachments. The server includes a database related to the plurality of plants. The database includes location information associated with the first plant. The first drone is further configured to: make a plurality of visits to the first plant, gather plant-specific information associated with the first plant, obtain a prescription based on the plant-specific information, wherein the prescription is associated with one or more requirements, based on the prescription, provide care to the first plant.

### CROSS-REFERENCE TO RELATED APPLICATIONS

This application claims priority to U.S. Provisional Patent Application No. 62/572,311, titled “INDIVIDUALIZED AND CUSTOMIZED PLANT MANAGEMENT USING AUTONOMOUS SWARMING DRONES AND ARTIFICIAL INTELLIGENCE,” filed Oct. 13, 2017, the content of which is hereby incorporated by reference for all purposes.

### FIELD OF THE INVENTION

The present disclosure relates generally to plant management, and more specifically to drones that are able to provide individualized and customized plant management.

### BACKGROUND

Traditional farm management requires a variety of traditional farming machines that are often expensive to acquire, operate, and maintain; it also often requires a large number of workers to regularly monitor the condition of the plants and to nourish/protect the plants as necessary. Despite the large number of workers and machines involved, individualized and customized plant care is rarely provided for a number of reasons. First, it is prohibitively expensive for workers to regularly gather detailed plant-specific information throughout the life cycle of the plant. Further, it is inefficient, difficult, and error-prone for workers to process a large volume of plant-specific data to identify potential issues with each plant and to develop corrective measures on a per-plant basis. Further, having workers provide plant-specific care is labor-intensive, as it requires one or more workers to travel to individual plants while carrying the necessary equipment. Having traditional farming machines perform plant-specific care is also impractical, given the relatively large size and the lack of agility of these machines.

With the surge of artificial intelligence (“AI”) and drone/robotics technologies, there is a need to automate some of the above-described tasks and to perform these tasks using small and lightweight devices. This would result in less waste, lower cost, healthier plant, higher yields, and more accurate insights into the plant and the farm for present and future farming purposes.

### BRIEF SUMMARY

A system for providing individualized and customized plant management using drones is described herein. In some embodiments, the system includes a plurality of drones, a docking station, and a server system. In some embodiments, each drone is assigned to an individual plant; that is, each drone is responsible for creating a particular plant (i.e., planting the seed), making regular visits to the plant, monitoring the growth of the plant, and carrying out various operations to nourish and protect to the plant. In some embodiments, the docking station includes a plurality of docks, which allow a docked drone to recharge its batteries and exchange data (e.g., images, sensor data, software updates) with the docking station. In some embodiments, the docking station also provides various supplies (fertilizer, water, ice, pesticide, insecticide, fungicide) and drone attachments (sprays, cutters, zappers) so that the drone can equip itself accordingly for the next visit to the plant. In some embodiments, the server system maintains a catalogue of each plant managed by the system based on the plant-specific data gathered by the drones. In some embodiments, the server system can track various metrics related to the growth of the plants, such as nourishment provided, protection provided, and growth pattern over time on a per-plant basis. By aggregating and analyzing the data stored on the server, the system can predict future issues (e.g., diseases, pests) that may occur to any individual plant or the entire farm and make adjustments to the management process to improve its effectiveness (e.g., via machine learning techniques).

In some embodiments, a system comprises a plurality of drones including a first drone, a docking station, and a server. The first drone is assigned to a first plant of the plurality of plants and is configured to accommodate a plurality of combinations of drone attachments. In some embodiments, the docking station comprises a plurality of drone attachments. In some embodiments, the server includes a database related to the plurality of plants. In some embodiments, the database includes location information associated with the first plant. In some embodiments, the first drone is further configured to: make a plurality of visits to the first plant, gather plant-specific information associated with the first plant, obtain a prescription based on the plant-specific information, wherein the prescription is associated with one or more requirements, based on the prescription, provide care to the first plant.

### DESCRIPTION OF THE FIGURES

FIG. 1 depicts a block diagram illustrating a system and environment for implementing a system that provides individualized and customized plant management using drones, according to various embodiments.

FIG. 2 depicts an exemplary process for providing individualized and customized plant management using drones, according to various embodiments.

FIG. 3A depicts an exemplary process for providing individualized and customized plant management using drones, according to various embodiments.

FIG. 3B depicts an exemplary process for providing individualized and customized plant management using drones, according to various embodiments.

FIG. 3C depicts an exemplary process for providing individualized and customized plant management using drones, according to various embodiments.

FIG. 3D depicts an exemplary process for providing individualized and customized plant management using drones, according to various embodiments.

FIG. 3E depicts an exemplary process for providing individualized and customized plant management using drones, according to various embodiments.

FIG. 3F depicts an exemplary process for providing individualized and customized plant management using drones, according to various embodiments.

FIG. 3G depicts an exemplary process for providing individualized and customized plant management using drones, according to various embodiments.

FIG. 3H depicts an exemplary process for providing individualized and customized plant management using drones, according to various embodiments.

FIG. 3I depicts an exemplary process for providing individualized and customized plant management using drones, according to various embodiments.

FIG. 3J depicts an exemplary process for providing individualized and customized plant management using drones, according to various embodiments.

FIG. 3K depicts an exemplary process for providing individualized and customized plant management using drones, according to various embodiments.

FIG. 3L depicts an exemplary process for providing individualized and customized plant management using drones, according to various embodiments.

FIG. 3M depicts an exemplary process for providing individualized and customized plant management using drones, according to various embodiments.

FIG. 3N depicts an exemplary process for providing individualized and customized plant management using drones, according to various embodiments.

FIG. 3O depicts an exemplary process for providing individualized and customized plant management using drones, according to various embodiments.

FIG. 3P depicts an exemplary process for providing individualized and customized plant management using drones, according to various embodiments.

FIG. 3Q depicts an exemplary process for providing individualized and customized plant management using drones, according to various embodiments.

FIG. 3R depicts an exemplary process for providing individualized and customized plant management using drones, according to various embodiments.

FIG. 4 depicts a functional block diagram of an exemplary drone configured to provide individualized and customized plant care, according to various embodiments.

FIG. 5A depicts an exemplary drone configured to provide individualized and customized plant care, according to various embodiments.

FIG. 5B depicts an exemplary drone configured to provide individualized and customized plant care, according to various embodiments.

FIG. 5C depicts an exemplary drone configured to provide individualized and customized plant care, according to various embodiments.

FIG. 5D depicts an exemplary drone configured to provide individualized and customized plant care, according to various embodiments.

FIG. 5E depicts an exemplary drone configured to provide individualized and customized plant care, according to various embodiments.

FIG. 5F depicts an exemplary drone configured to provide individualized and customized plant care, according to various embodiments.

FIG. 5G depicts an exemplary drone configured to provide individualized and customized plant care, according to various embodiments.

FIG. 6A depicts the interior of an exemplary docking station, according to various embodiments.

FIG. 6B depicts the exterior of an exemplary docking station, according to various embodiments.

FIG. 6C depicts an exemplary storage space for drone attachments and supplies, according to various embodiments.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Embodiments of a system for providing individualized and customized plant management using drones is described herein. The system includes a plurality of drones, a docking station, and a server system. In some embodiments, each drone is assigned to an individual plant; that is, each drone is responsible for creating a particular plant (i.e., planting the seed), making regular visits to the plant, monitoring the growth of the plant, and carrying out various operations to nourish and protect to the plant. The docking station includes a plurality of docks, which allow a docked drone to recharge its battery and exchange data (e.g., images, sensor data, software updates) with the docking station. The docking station also provides various supplies (fertilizer, water, ice, pesticide, insecticide, fungicide) and drone attachments (sprays, cutters, zappers) so that the drone can equip itself accordingly for the next visit to the plant. Additionally or alternatively, various supplies and drone attachments are kept in a storage space separate from the docking station. The server system maintains a catalogue of each plant managed by the system based on the plant-specific data gathered by the drones. The server system can track various metrics related to the growth of the plants, such as nourishment provided, protection provided, and growth pattern over time on a per-plant basis. By aggregating and analyzing the data stored on the server, the system can predict future issues (e.g., diseases, pests) that may occur to any individual plant or the entire farm and make adjustments to the management process to improve its effectiveness (e.g., via machine learning techniques). In some embodiments, various AI algorithms are implemented on the hardware and/or software of the drones, on the hardware and/or software of the server, on the hardware and/or software of the docking station, or a combination thereof, to automate various aspects of the management process and to minimize human intervention.

The present system has a number of advantages over traditional farm management systems. With the help of drones and a central server, the system can gather detailed information related to the individual plants on a farm throughout their life cycles and perform analysis on the large volume of data in an efficient manner. This allows an accurate assessment of each plant at any given time. By aggregating data related to multiple plants and analyzing the data over time, the system can provide better understanding and prediction for individual plants as well as for the farm as a whole. Further, with deep knowledge of the individual plants and the farm, the system can carry out operations in a more precise and efficient manner. For example, if the system can pinpoint the exact location of a fungus infection on a plant, the system can instruct the drone to apply chemical on the exact location, thus reducing waste of resources.

Additionally, because any given plant is provided with individualized and customized care, the plants are healthier overall, thus producing higher yields. Furthermore, drones are more lightweight, more durable, and less expensive relative to traditional farming machines. Drones are also more effective and versatile, as they may be equipped with various powerful attachments (e.g., HD camera, sensors) and may be configured to carry different attachments at any given time. Thus, in contrast to traditional farm machines, drones are cheaper to acquire, maintain, and operate, while producing better results.

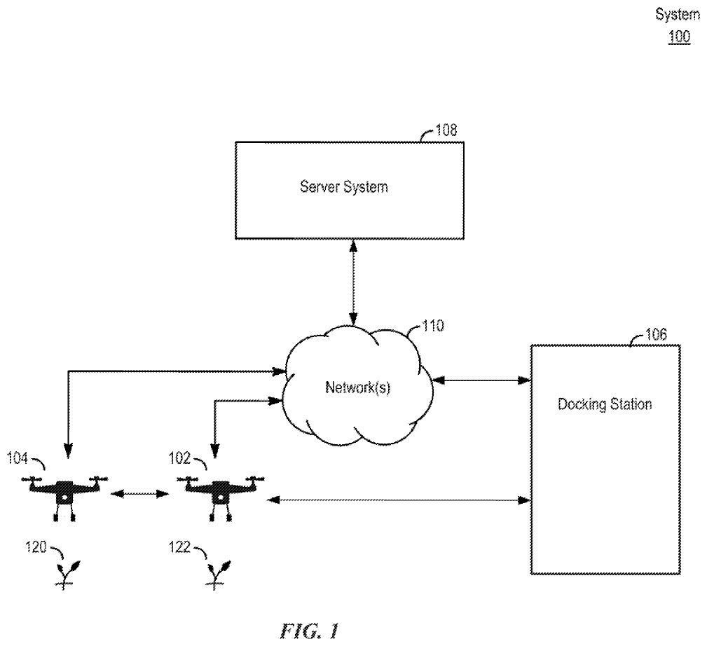

FIG. 1 illustrates a block diagram of system 100 according to various embodiments. In some embodiments, system 100 provides individualized and customized plant management using multiple drones. System 100 includes one or more drones (e.g., drones 102 and 104), a docking station 106, and a server system 108. The one or more drones, the docking station 106, and the server system 108 may communicate with each other via one or more networks 110.

The system provides individualized and customized care to a plurality of plants, such as plants 120 and 122. In the depicted example, the drone 104 is assigned to care for plant 120 and the drone 102 is assigned to care for plant 122. Accordingly, the drone 104 is responsible for creating the plant 120 (i.e., planting the seed), making regular visits to the plant 120, monitoring the growth of the plant 120, and carrying out various operations to provide nourishment and protection for the plant 120. Similarly, the drone 102 is responsible for carrying out the similar tasks with respect to the plant 122. In some embodiments, the one-drone-per-plant model helps to minimize the number of drones in the sky at a given time, thus reducing cost. It should be appreciated that, in some instances, one drone may manage multiple plants and/or multiple drones may manage a single plant. For example, the system may assign one drone to manage plants growing in the same row, on the same field, or on the same farm. As another example, the system may assign one drone to water plants while assigning another drone to spray pesticide. As yet another example, the system assigns whichever drone available in the docking station to perform an outstanding task. It should be appreciated that assignment of drones may vary depending on the number/type of plants, the number/type of tasks, etc. It should be appreciated that, to achieve optimal operation, the system can allocate tasks across one or more drones, the server, and the docking station based on the computation resources required to analyze different issues and the different processing power of the various types of drones, the docking station, and the server.

The server system 108 maintains a catalogue of each plant managed by the system in accordance with some embodiments. Based on the plant-specific data gathered by the drones, the server system 108 can track various metrics related to the plants, such as nourishment provided, protection provided, and growth pattern, over time on a per-plant basis. In some embodiments, the server includes one or more processing units that are capable of analyzing the data using AI algorithms By aggregating and analyzing the data stored on the server, the system can predict future issues (e.g., diseases, pests) that may occur to any individual plant or the entire farm and make adjustments to the management process to improve its effectiveness (e.g., via machine learning techniques). Server system 108 can be implemented on one or more standalone data processing apparatus or a distributed network of computers. In some embodiments, server system 108 also employs various virtual devices and/or services of third-party service providers (e.g., third-party cloud service providers) to provide the underlying computing resources and/or infrastructure resources of server system 108.

The docking station 106 includes a plurality of docks, each of which can accommodate a drone, in accordance with some embodiments. An exemplary dock includes a charging unit to allow a drone to recharge its battery. The dock also includes one or more data ports for transferring data from the drone to the docking station (e.g., sensor data, images, videos) or from the docking station to the drone (e.g., software updates, prescriptions, and prescription requirements). The docking station also provides various supplies (fertilizer, water, ice, pesticide, insecticide, fungicide) and drone attachments (sprays, cutters, zappers) so that the drone can equip itself accordingly for the next visit to the plant. In accordance with some embodiments, the docking may further include one or more processing units for analyzing the plant-specific data and formulating prescriptions.

As depicted, the drones 102 and 104, the docking station 106, and the server system 108 can communicate with each other via the communication network 110. The communication network 110 can be configured using any combination of networking devices. In some embodiments, the drones 102 and 104 can communicate directly with the server system 108 while they are making plant visits (e.g., using a wireless connection). Alternatively or additionally, the drones can communicate directly with the docking station while they are making plant visits (e.g., via a wireless connection) and/or while they are docked in the docking station (e.g., via data ports). In some embodiments, the docking station 106 relays data between the drones 102 and 104 and the server 108. As discussed below, the processing of plant-specific data may be performed by the drones 102 and 104, by the docking station 106, by the server system 108, or a combination thereof. The communication between the drones and the server and among the drones themselves allows implementation of swarm intelligence. Specifically, the behavior of each drone is based at least partially on shared rules and/or information gathered from other drones. The implementation of swarm intelligence allows the multiple drones to work together effectively. For example, in the context of routing, the drones can avoid crashing into each other and can set routes based on the routes previously taken by other drones.

As discussed above, various AI algorithms are implemented on the hardware and/or software of the drones, on the hardware and/or software of the server, on the hardware and/or software of the docking station, or a combination thereof, to automate various aspects of the management process and to minimize human intervention. As such, in some embodiments, the drones are in substantially constant contact with the server to ensure that information are gathered, shared, and processed properly and in real time. For example, constant communication may be needed to allow images/videos of the plant to be live streamed to the server for the AI algorithms to work properly, in some embodiments.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, the system additionally includes human operators and traditional farming machines. While the system can largely automate the provision of individualized and customized care and improve its performance over time via AI learning capabilities, human operators may be needed from time to time to adjust the configurations of the system, troubleshoot the system, and address rare issues (e.g., rare diseases, rare pests). Further, given the relatively small size of the drones, the drones may not be fit to perform certain operations (e.g., harvesting the crops). As such, traditional farming machines may be used to complement the operation of the drones.

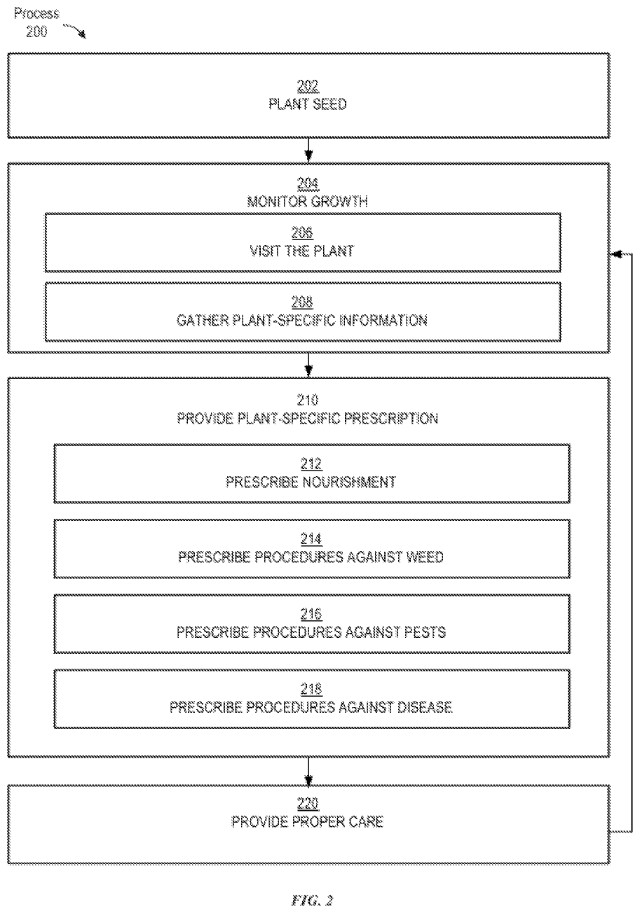

FIG. 2 illustrates a process 200 for providing individualized and customized plant management using drones, accordingly to various examples. Process 200 is performed, for example, using one or more drones and one or more control systems for the drones. In some embodiments, process 200 is divided up in any manner between the one or more drones (e.g., drone 102, drone 104) and the one or more control systems (e.g., docking station 108, server 106). Thus, while portions of process 200 are described herein as being performed by particular devices and/or systems, it will be appreciated that process 200 is not so limited. In process 200, some blocks are, optionally, combined, the order of some blocks is, optionally, changed, and some blocks are, optionally, omitted. In some embodiments, additional steps may be performed in combination with the process 200.

For purposes of illustration, process 200 is described below under a model in which one individual drone is assigned to one individual plant. That is, the individual drone is responsible for maintaining the health of the assigned individual plant throughout the plant's life cycle. It should be appreciated, however, that the process 200 is not so limited. For example, process 200 may be performed under a model in which one individual drone is assigned to one task and/or subtask, instead of being assigned to an individual plant. For example, a first drone may be assigned to the task of planting seeds, while a second drone may be assigned to the task of watering plants. As another example, process 200 may be performed under a model in which one individual drone is assigned to one time slot. For example, a first drone may be assigned to operate between 8 AM-12 PM, while a second drone may be assigned to operate between 8 PM-12 AM.

At block 202, a drone plants a seed. In some embodiments, the drone acquires a predetermined location to deposit the seed from, for example, the docking station and/or the server system via a network. The location can be an absolute location (e.g., specified by GPS coordinates), a relative location (e.g., 1 meter away an existing plant, row 12 in the field), or a combination thereof. In some embodiments, a drone can receive from the server system instructions to plant a particular type of seed at predetermined GPS coordinates. In some embodiments, the drone can receive instructions to plant a particular type of seed in a general location (e.g., a particular field, a particular row in the field) and determine an ideal location to deposit the seed, for example, by running AI algorithms using local hardware on the drone. To plant the seed, the drone may obtain necessary drone attachments (e.g., a digger, a seed carrier) and the proper seed from the docking station and/or a separate storage space.

At block 204, the drone monitors the growth of the seed, as well as the corresponding seedling and the corresponding plant throughout the life cycle of the plant. At block 206, the drone makes periodic visits (e.g., hourly, daily, weekly) to the plant. In some embodiments, the frequency of the periodic visits is based on the type of plant, as some types of plants by nature need more frequent monitoring and caring than other types of plants. In some embodiments, the frequency of the periodic visits is based on occurrence of specific situations such as onset of diseases, as the drone may determine (e.g., using AI algorithms) that an infected plant needs to be visited more frequently. In some embodiments, special visits may be triggered by a human operator who receives an alert from the system regarding special circumstances. In summary, a visit to the plant may be triggered as a result of predetermined frequency (e.g., based on the type of plant) and special circumstances (as determined by AI algorithms or human operators).

To visit the plant, the drone identifies a route to reach the plant based on a number of factors. In some embodiments, the drone first determines an initial route based on the known location of the plant (e.g., GPS coordinates, address of the field). The drone may further refine/revise the initial route based on environmental factors (e.g., weather, physical obstacles, other drones in flight) and/or issues encountered during previous trips taken. As discussed above, the drone may include hardware and/or software units implementing swarm intelligence. Specifically, communication is maintained among the drones and between the drones and the server, and the behavior of each drone is based at least partially on shared rules and/or information gathered from other drones. The implementation of swarm intelligence allows the multiple drones to work together effectively. In the context of routing, the drones avoid crashing into each other and can set routes based on the routes previously taken by other drones.

In order to identify the plant once the drone is in proximity to the plant, the drone can use a number of factors, such as the known location (e.g., GPS coordinates) of the plant, the appearance of the plant (e.g., size, shape, color), and/or existing identifiers (e.g., bar code, RFID chip) placed on or near the plant. For example, the drone may capture an image of multiple plants growing at the known location of the plant, and the image is analyzed using classification algorithms such that the precise location of a plant of the right type is determined. As another example, the drone may fly near the known location of the plant, and scans all bar codes on the stems of the nearby plants to identify the plant assigned to the drone. After the plant is identified, the drone may determine whether the previously known location and/or identifying characteristics of the plant needs to be updated and if so, store the new location and/or new identifying characteristics of the plant.

At block 208, the drone gathers plant-specific information. The plant-specific information can include any information related to the health of the plant, such as data related to the appearance of the plant and data related to the surrounding environment of the plant. The information can include digital data and/or physical samples. For example, the drone may capture one or more images or video clips of the plant and/or the surrounding environment. As another example, the drone may obtain samples of the soil in which the plant is grown, samples of the leaves on the plant, etc. In some embodiments, the plant-specific data is gathered during one or more of the visits at block 206.

The data gathered at block 208 can be analyzed to obtain information related to the growth and the health of the plant. For example, images and videos may be analyzed to determine whether the appearance of the plant (e.g., size, color) is indicative of potential health issues and/or potential issues with the surrounding environment. For example, if the size of the plant is significantly smaller than the average size of a plant of the same type and age, the system can determine that there are issues with the health of the plant (e.g., disease) or with the surrounding environment (e.g., weed and pests). The images and videos can be further analyzed to identify the presence of weeds, pests, broken limbs from the plant, etc. For example, if analysis of the images reveal that more than one plant are growing in an area and the area is known to have only one seedlings planted by the drone, the system can determine that there are unwanted weeds growing around the plant. Further, physical samples obtained by the drone can be analyzed to obtain additional information. For example, soil samples are analyzed to obtain information related to the pH level, the moisture level, the density of the soil, etc. Based on the analysis of the soil sample, the system can determine whether the farm provides the ideal growing environment for the plant and take actions accordingly, as described below.

The analysis of the data gathered at block 208 can be performed by the drone, by the docking station, the server system, or a combination thereof. In some embodiments, the drone can perform a number of relatively simple analysis onsite. However, for more resource-intensive analysis, the drone may provide the data to the docking station and/or the server system such that the more resource-intensive analysis can be done offsite. For example, the drone can analyze the pH value of the soil onsite using specialized sensors, thus eliminating the need to carry sample soil back to the docking station. On the other hand, the drone may forego analyzing the captured images and video clips using the hardware of the drone but instead may store the captured images and video clips locally. Once the drone returns to the docking station, the drone may provide the digital data to the docking station and/or upload the digital data to the server for further analysis. In some embodiments, the drones are in substantially constant contact with the server to ensure information are gathered, shared, and processed properly and in real time. For example, substantially constant communication via wireless, cellular, and/or Bluetooth connection may be needed to allow images/videos of the plant to be live streamed to the server for the AI algorithms to work properly, in some embodiments.

At block 210, the system provides one or more plant-specific prescriptions. The prescriptions specify actions to be performed by the system (drones, the docking station, and/or the server) in furtherance of maintaining the health of the individual plant. In some embodiments, the prescriptions are formulated based on plant-specific information gathered in block 208. In some embodiments, the prescriptions are formulated based on external information such as known or predicted weather information. The prescriptions may include actions to be performed by the drone (e.g., providing plant nourishment, providing protection against weeds/pests/disease, gathering specific type of plant-specific information in future visits), the docking station (e.g., procuring provisions such as plant nourishment and pesticides), the server (e.g., issuing an alert to a human operator, flagging issues in the database, monitoring specific trends), or a combination thereof.

At block 212, the system prescribes nourishment (e.g., fertilizer, water) to the plant. The prescription may specify any information necessary for the system to fulfill the prescription, such as the type of fertilizer, the amount of fertilizer, and the amount of water to be applied. The prescription may be formulated based on plant-specific data (e.g., information gathered in block 208), external data (e.g., weather), or a combination thereof. For example, the amount and type of the fertilizer may be based on the plant type, the amount of fertilizer previously applied, effectiveness of previously applied fertilizer (e.g., obtained based on the images captured by the drone using AI algorithms), the current status of the plant (e.g., obtained based on the images captured by the drone using AI algorithms), etc.

At block 214, the system prescribes procedures against weeds. The prescription may specify a specific type of procedure for disrupting and/or removing weeds, such as cutting the weeds using blades or propellers, spraying chemicals on the weeds, and providing electrical shock to the weeds. The procedure(s) prescribed can be based on the type of weeds discovered, the size of the weeds, the proximity of the weed to the plant, the effectiveness of previously used procedures, or a combination thereof. For example, an analysis of the images of the plant (e.g., captured by the drone) may reveal that the weeds are relatively small in size and located relatively far from the plant. Accordingly, the system may prescribe that a certain type of blade to be used to cut the weeds, as the blades would not be applied close to the plant enough to harm the plant. On the other hand, if the weeds are known to be close to the plant, the system may prescribe that a small amount of chemical be applied directly onto the weeds. Based on the data gathered by the drone, the system can determine the precise location of the weeds and prescribe that the chemicals be applied directly on top of the target, thus reducing waste and minimizing damage to the plant.

At block 216, the system prescribes procedures against pests (e.g., parasites, rodent, moles, rabbits). The prescription may specify a specific type of procedure for disrupting and/or removing pests, such as applying electrical shock to the pests, knocking the pests off the plant (e.g., using blades, sprays, or propellers), and applying pesticide. The procedure(s) prescribed can be based on the type of pests discovered, the size of the pests, the proximity of the pests to the plant, the effectiveness of previously used procedures, or a combination thereof. For example, an analysis of the images of the plant (e.g., captured by the drone) may reveal that the pests are of a species that is known to be difficult to eradicate. Accordingly, the system may prescribe that a certain type of strong pesticide to be applied. Based on the data gathered by the drone, the system can determine the location of the pests and/or the nest of the pests and prescribe that the pesticide be applied directly on top of the target, thus reducing waste and minimizing harm to the plant. In some embodiments, the system may analyze the data gathered by the drone (e.g., images/videos) to detect living organisms located near the plant (e.g., using classification algorithms) and determine that the organism is not harmful to the plant (e g, mantises, bees), and thus forego prescribing procedures against the detected organisms. In some embodiments, for certain type of pests (e.g., relatively large animals such as rabbits), the system may issue an alert (e.g., via a software) to the human operator regarding the location of the detected pests.

At block 218, the system prescribes procedures against diseases contacted by the plant. The prescription may specify a specific type of procedure for eliminating the diseases, such as cutting the infected portion (e.g., leaf) using blades or propellers and applying chemicals on the plant. The procedure(s) prescribed can be based on the type of disease discovered, the stage of the disease, the effectiveness of previously used procedures, or a combination thereof. For example, an analysis of the images of the plant (e.g., captured by the drone) may reveal that only a limb of the plant has been infected by the disease and the disease has not otherwise spread. Accordingly, the system may prescribe that the infected limb by cut by blades or applying fungicide only to the infected portion, thus minimizing damage to the plant. If, however, the above-prescribed procedure is not effective, the system may prescribe spraying fungicide on the entire plant.

The above-described prescriptions can be formulated by the drone, by the docking station, by the server, by the human operator, or a combination thereof. As discussed above, the drone can perform a number of relatively simple analysis onsite and as such may be able to provide simple prescriptions onsite. For example, the drone may determine that the pH value of the soil onsite and, based on the pH value and the information about the plant, prescribe a simple procedure for adjusting the pH value of the soil onsite. As another example, the server may receive data gathered from the drone (e.g., transmitted directly from the drone or relayed from the docking station), along with any preliminary analysis already performed (e.g., by the drone), and formulate detailed prescriptions using more resource-intensive algorithms. After the server formulates the prescriptions, the server communicates the prescriptions to the drone if necessary. The server may transmit the prescriptions to the drone directly via, for example, a wireless network. Alternatively, the server may transmit the prescriptions to the docking station, which in turn relays the prescriptions to the drone (e.g., when the drone is docked in the station).

At block 220, the system provides proper care to the plant, for example, by taking actions in accordance with the prescriptions provided in block 210. In some embodiments, a prescription can be associated with one or more hardware requirements and/or software requirements. For example, a prescription prescribing a type of pesticide to be applied to the plant requires the drone to be equipped with the pesticide, spray(s), and software (e.g., a pesticide-applying module) necessary to properly apply the pesticide. As another example, a prescription prescribing weed removal requires the drone to be equipped with cutter(s) of a proper size and software (e.g., a weed-removal module) necessary to cut the weed without harming the plant. As another example, a prescription specifying a type of plant-specific data to be gathered requires the drone to be equipped with the proper sensor(s). As such, in preparation to fulfill the prescriptions, the drone may update its hardware and/or software attachments based on the requirements associated with the prescriptions.

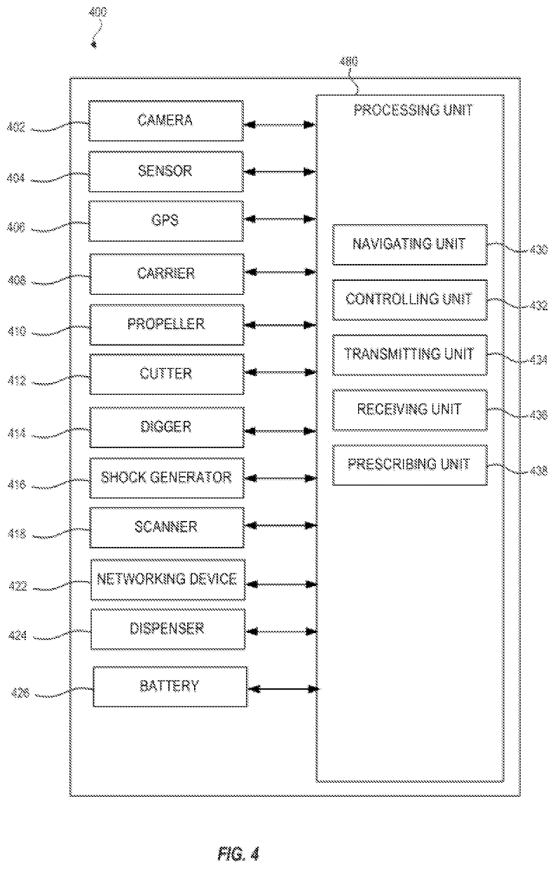

In some embodiments, the drone needs to update its hardware attachments and/or software modules based on the requirements associated with the prescription. In some embodiments, the drone returns to the docking station and/or a separate storage space to obtain the hardware attachments and/or software modules needed. For example, to fulfill a prescription to spray pesticide, the drone may return to the docking station to swap out the proper type of the spray and to obtain the proper amount of pesticide. The drone may further download and install the proper software module to operate the spray. In some embodiments, the drone can perform the necessary updates without returning to the dock. For example, the drone may carry the proper spray and pesticide when it goes to the field. In response to receiving a prescription to spray pesticide, the drone can automatically install the spray onsite and download necessary software updates from the server via a wireless network. Exemplary hardware attachments and software modules that can be equipped on the drone are described in detail below with respect to FIG. 4.

It should be appreciated that the hardware and/or software requirements associated with various prescriptions may be stored on the drone, on the server, and/or on the docking station. As such, in some instances, the drone can gather data, perform preliminary analysis to obtain a simple prescription along with the requirements, and fulfill the prescription on the field without returning to the docking station. In some other instances, the drone can gather plant-specific data, transmit the gathered data, receive a prescription from the server, determine whether to return to the docking station (e.g., based on the requirements associated with the prescription), and return to the docking station and/or a separate storage space to obtain the necessary attachments if necessary. In some other instances, the drone can gather plant-specific data, return to the docking station, upload the data, wait for the server to formulate a prescription, and travel back to the field after getting the necessary attachments.

It should be further appreciated that multiple aspects of the drone operation may be autonomous. For example, the drone is able to identify routes to various destinations (e.g., from the field to the docking station, from the docking station to the plant) and safely navigate to the destinations without human intervention. As another example, the drone is able to carry out operations (e.g., spraying pesticide, watering the plant) in a precise manner without the help of a human operator. In some examples, the autonomous operations of the drone are based on AI algorithms implemented on the local software and/or hardware of the drone, on the local software and/or hardware of other drones, on the local software and/or hardware of the server, or a combination thereof.

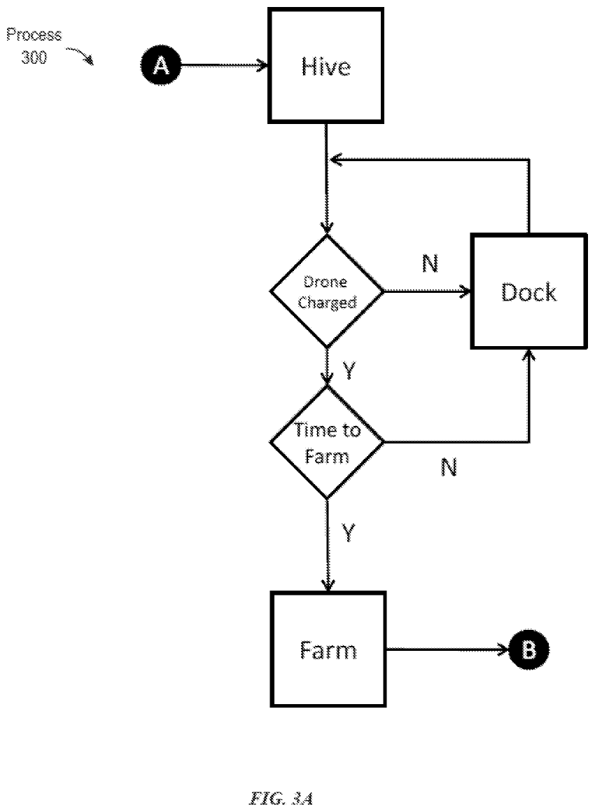

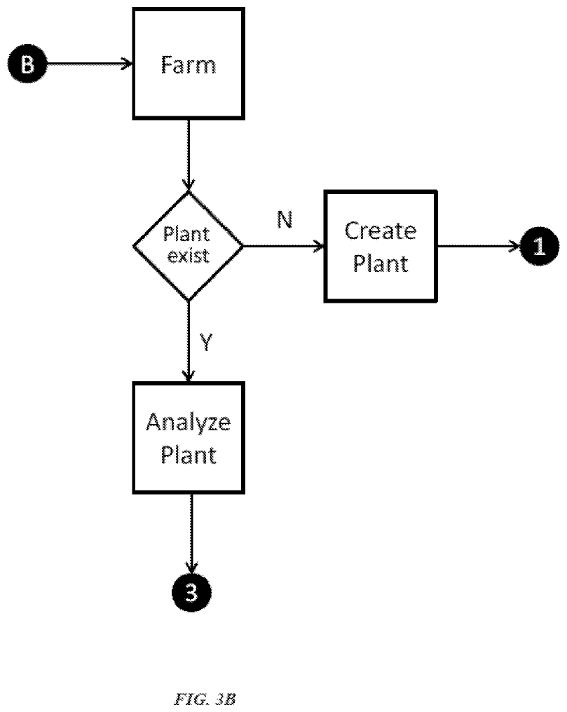

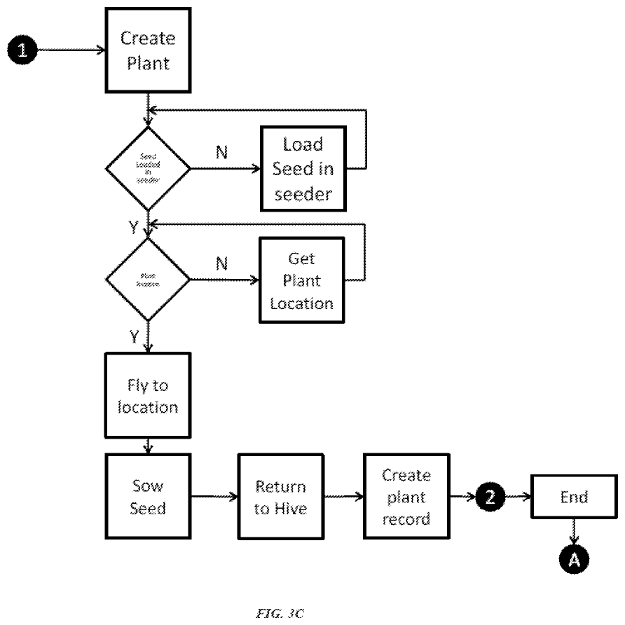

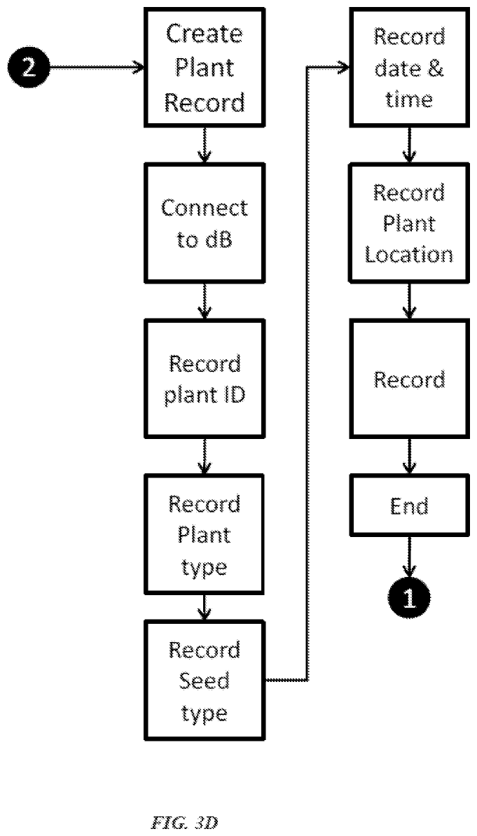

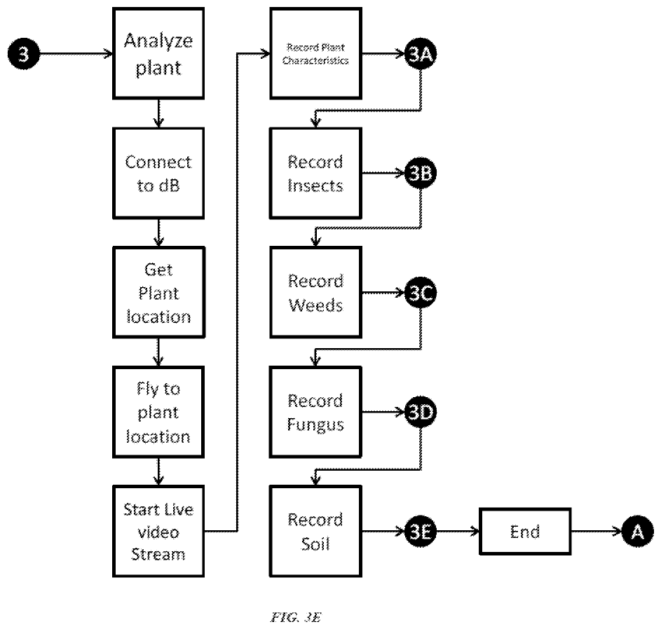

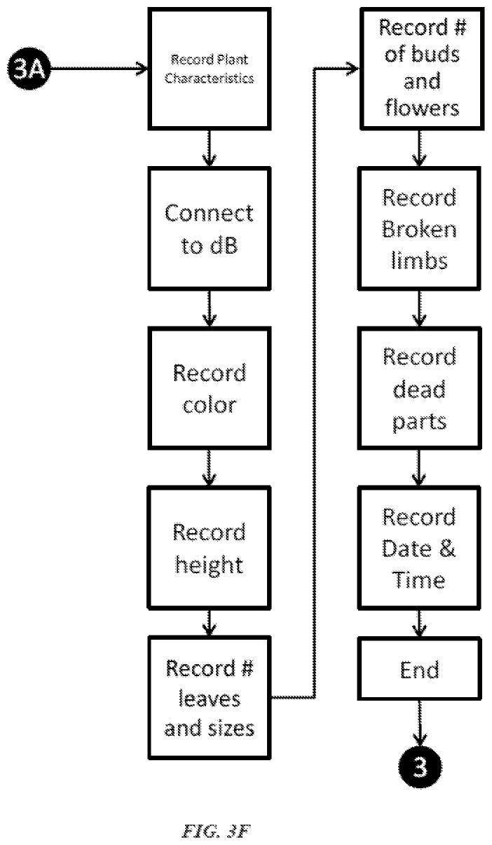

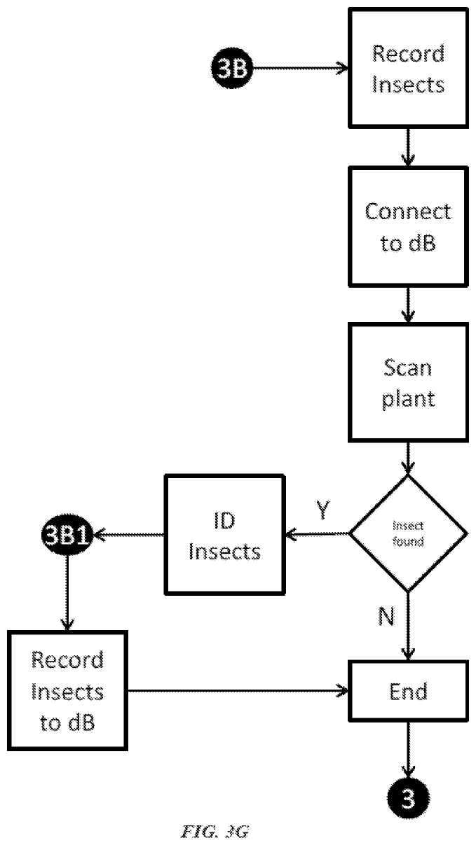

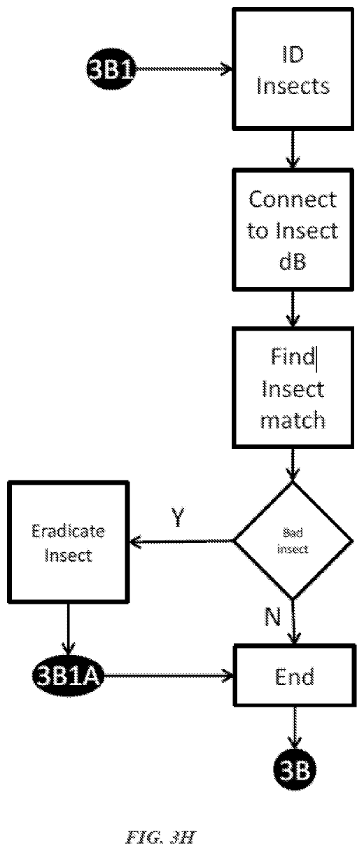

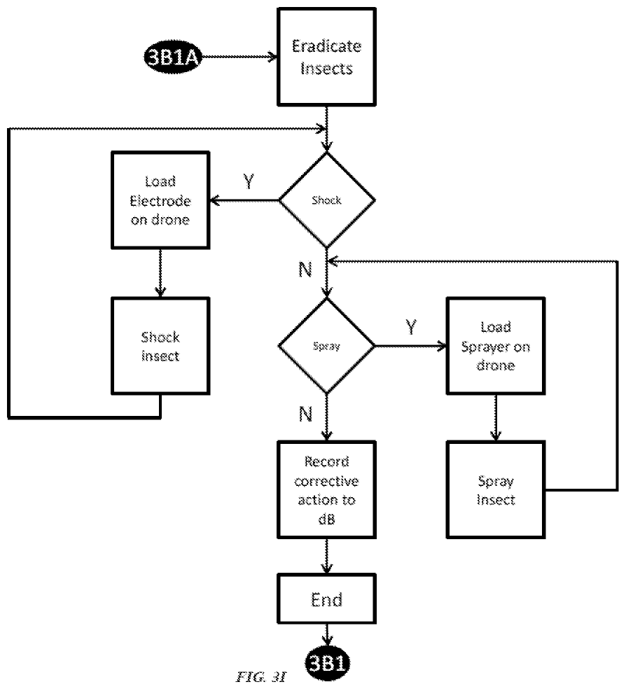

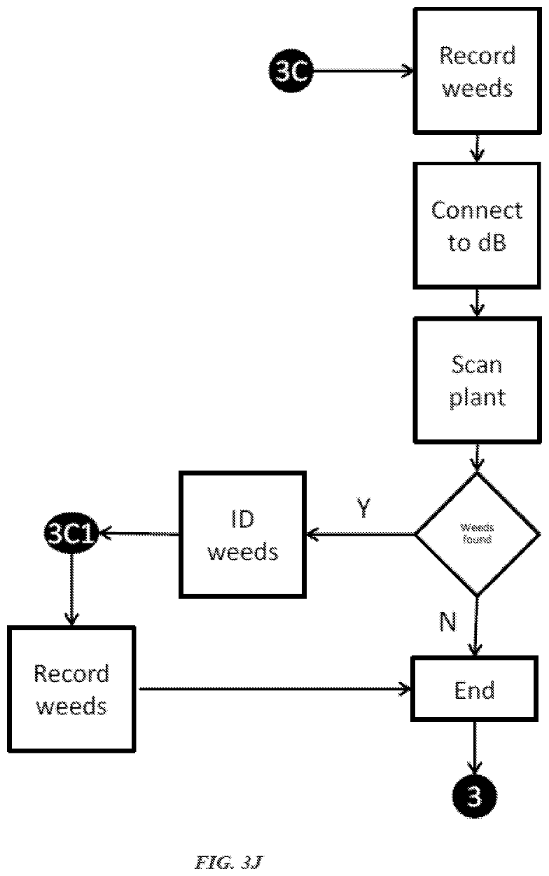

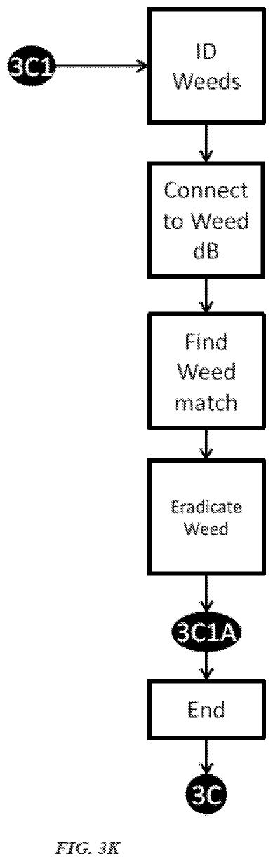

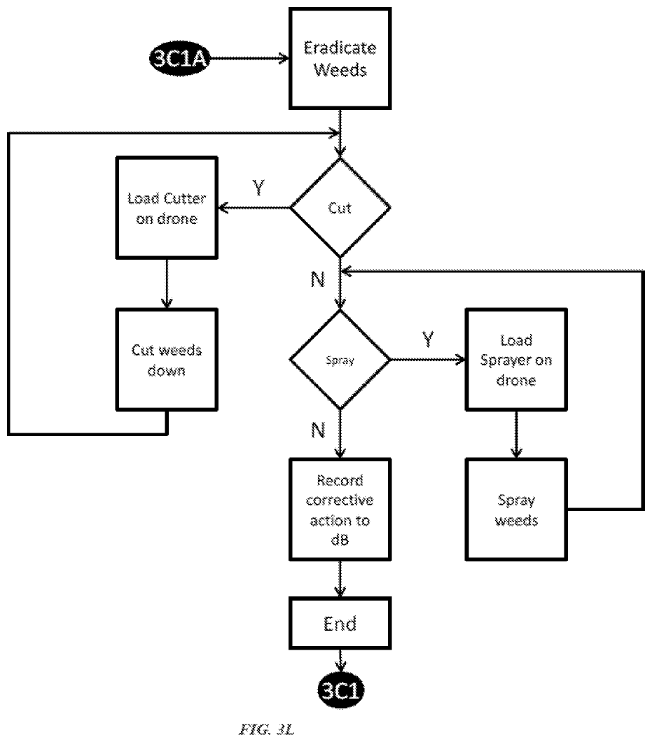

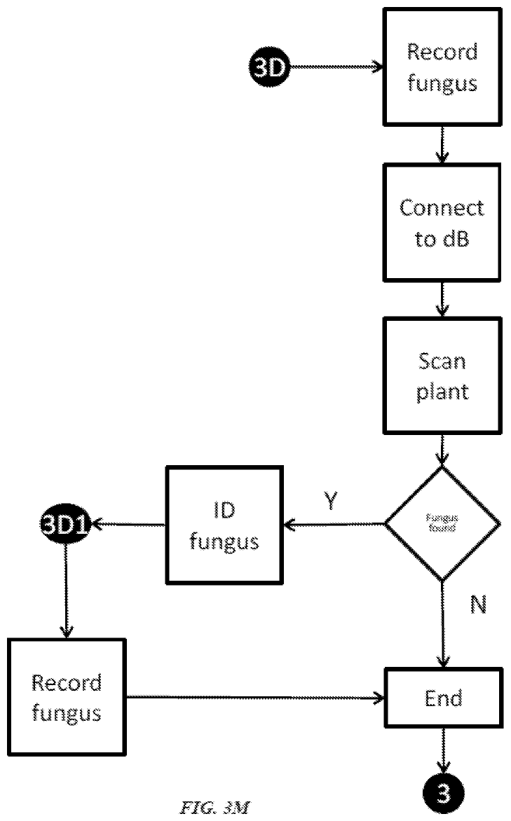

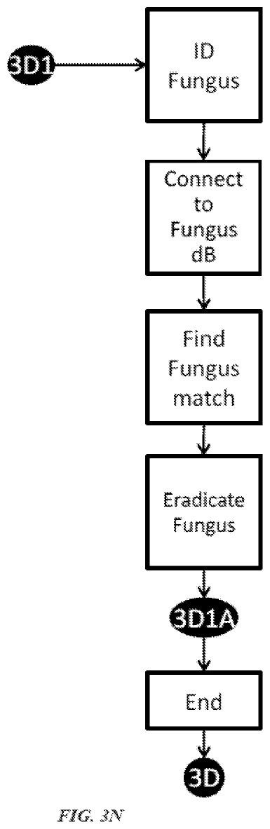

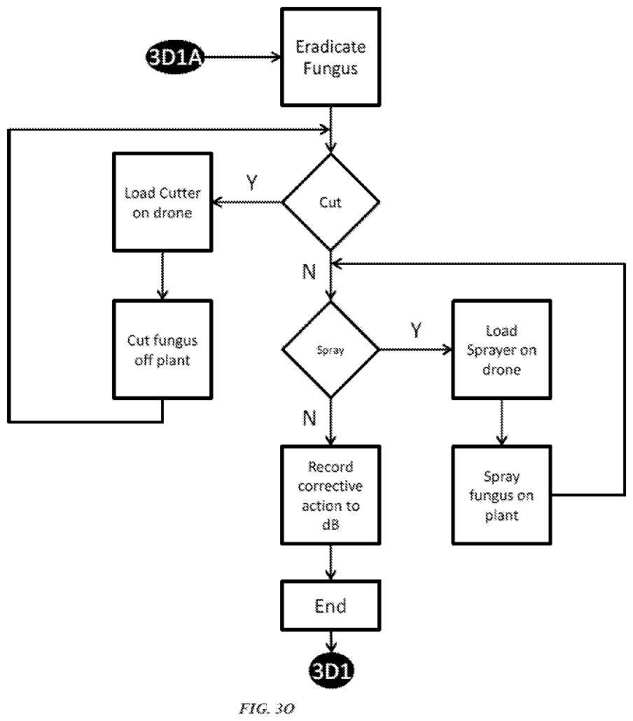

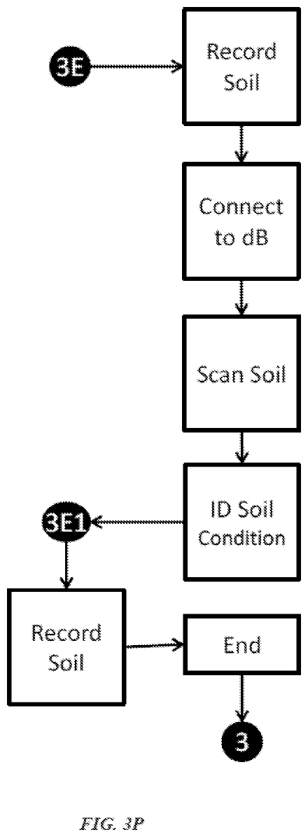

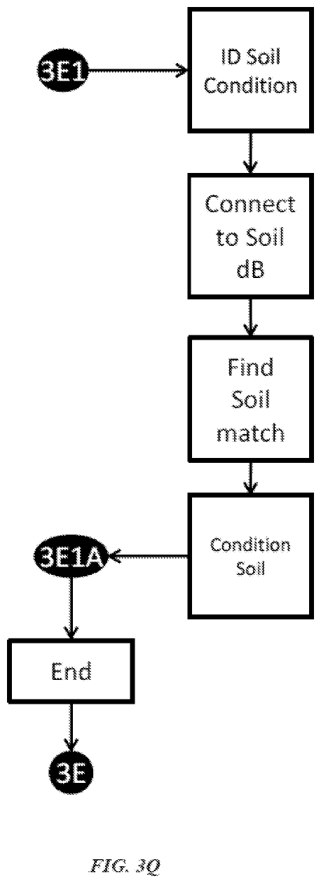

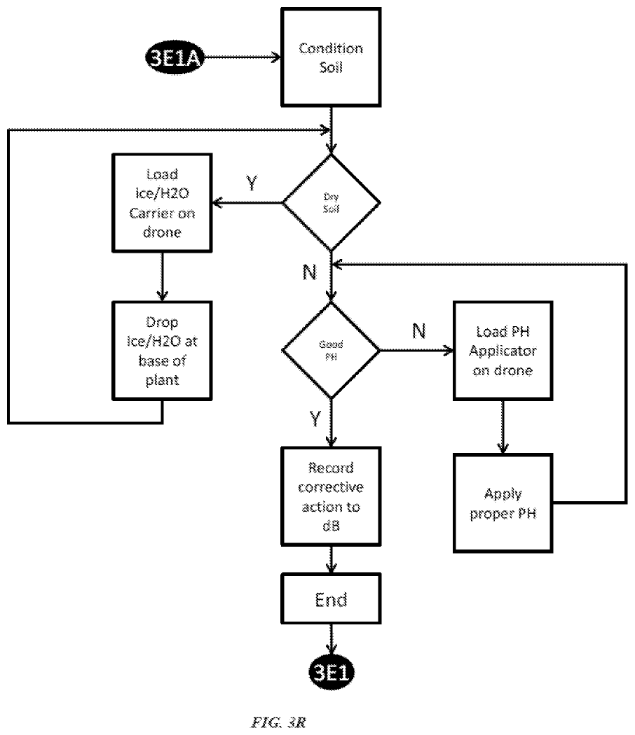

In accordance with some embodiments, FIG. 3 illustrates another process 300 for providing individualized and customized plant management using drones. Process 300 is performed, for example, using one or more drones and one or more control systems for the drones. In some embodiments, process 300 is divided up in any manner between the one or more drones (e.g., drone 102, drone 104) and the one or more control systems (e.g., docking station 108, server 106). Thus, while portions of process 300 are described herein as being performed by particular devices and/or systems, it will be appreciated that process 300 is not so limited. In process 300, some blocks are, optionally, combined, the order of some blocks is, optionally, changed, and some blocks are, optionally, omitted. In some embodiments, additional steps may be performed in combination with the process 300.

As depicted in FIG. 3A, the process starts when a drone is docked in a docking station (“hive”). If the drone determines that it is sufficiently charged (e.g., based on battery information) and that it is time to farm, the drone starts the farming process. In some embodiments, the drone determines whether it is time to farm based on signals received from the docking station or the server. An exemplary farming process is depicted in FIG. 3B. The drone first determines whether a plant exists. The determination may be made based on the records stored on the server system. If the plant does not exist, the drone proceeds to create the plant (FIG. 3C). If the drone determines that the plant does exist, the drone proceeds to analyze the plant (FIG. 3E).

An exemplary process for creating a plant is depicted in FIG. 3C. The drone first determines whether there are seeds loaded in the seed carrier (e.g., seeder) and, if not, loads one or more seeds into the seed carrier. The drone also obtains location to create the plant. The drone then flies to the plant location, sows the seed, and returns to the hive. At the hive, the drone creates a record for the plant (FIG. 3D). An exemplary process for creating a plant record is depicted in FIG. 3D. The process includes: connecting to a database (e.g., stored on the server), recording an unique plant ID, recording a plant type, recording a seed type, recording date and time of plant creation, recording plant location, and saving the record. After the record is created, the current process ends and another instance of process 300 may begin.

An exemplary process for analyzing the plant is depicted in FIG. 3E. At the hive, the drone connects to the database (e.g., stored in the server), gets the plant location, and flies to the plant based on the location. At the location of the plant, the drone starts a live video stream. The drone also gathers and records various plant-specific information. Specifically, the drone can record plant characteristics (FIG. 3F) as well as information related to insects (FIG. 3G), weeds (FIG. 3J), fungus (FIG. 3M), and soil (FIG. 3P). After the recordings are complete, the current process ends and another instance of process 300 may begin.

An exemplary process for recording plant characteristics is depicted in FIG. 3F. As depicted, the recorded plant characteristics include color, height, number of leaves and sizes, number of buds and flowers, broken limbs, dead parts, date and time of the recording, etc. As discussed above with respect to FIG. 2, the recorded plant characteristics may be transmitted to the server while the drone is on the field, or saved locally and uploaded to the server when the drone returns to the docking hive. In some embodiments, the recorded plant characteristics are obtained at the server from raw images or videos uploaded by the drone.

An exemplary process for recording information related to insects is depicted in FIG. 3G. As depicted, the drone connects to the database (e.g., at the server) and scans the plant. If an insect is found, the insect is identified and recorded in the database. As depicted in FIG. 3H, identifying the insect includes finding a match in an insect database (e.g., a database of known insects) and determining whether the insect is harmful to the plant. If so, the insect is eradicated. If the insect is not harmful to the plant, the system foregoes taking any action against the insect. An exemplary process for eradicating insects is depicted in FIG. 3I. Depending on the type of insect and the type of plant, the drone may deploy electrical shock to the insect (after loading electrode on the drones) and/or spray the insect (after loading a sprayer on the drone). The drone then records the corrective action(s) taken to the database.

An exemplary process for recording information related to weeds is depicted in FIG. 3J. As depicted, the drone connects to the database (e.g., at the server) and scans the plant. If weeds are found, the weeds are identified and recorded in the database. As depicted in FIG. 3K, identifying the weeds includes finding a match in a weed database (e.g., a database of known weeds). After the match is found, the drone proceeds to eradicate the weeds. An exemplary process for eradicating weeds is depicted in FIG. 3L. Depending on the type of weeds and the type of plant, the drone may cut the weeds (after loading a cutter on the drone) and/or spray the insect (after loading a sprayer on the drone) as necessary. The drone then records the corrective action(s) taken to the database.

An exemplary process for recording information related to fungus is depicted in FIG. 3M. As depicted, the drone connects to the database (e.g., at the server) and scans the plant. If fungus is found, the fungus are identified and recorded in the database. As depicted in FIG. 3N, identifying the fungus includes finding a match in a fungus database (e.g., a database of known fungi). After the match is found, the drone proceeds to eradicate the fungus. An exemplary process for eradicating fungus is depicted in FIG. 3O. Depending on the type of fungus and the type of plant, the drone may cut the fungus or infected plant parts (after loading a cutter on the drone) and/or spray the fungus on the plant (after loading the sprayer on the drone) as necessary. The drone then records the corrective action(s) taken to the database.

An exemplary process for recording information related to soil is depicted in FIG. 3P. As depicted, the drone connects to the database (e.g., at the server) and scans the soil. The soil conditions are identified and recorded in the database. As depicted in FIG. 3Q, identifying the soil conditions includes finding a match in a database (e.g., a database of known soil conditions). After the match is found, the drone proceeds to condition the soil as necessary. An exemplary process for conditioning soil is depicted in FIG. 3R. Depending on the type of soil condition and the type of plant, the drone may take measures to make the soil less dry (e.g., by loading ice/water on the drone and dropping ice/water at the base of the plant). The drone may also take measures to adjust the pH of the soil (e.g., by loading and applying substances that alter the pH of the soil). The drone then records the corrective action(s) taken to the database.

In accordance with some embodiments, FIG. 4 shows a functional block diagram of a drone 400 configured in accordance with the principles of the various described embodiments, including those described with reference to FIGS. 1, 2, and 3A-R. The functional blocks of the drone are, optionally, implemented by hardware, software, or a combination of hardware and software to carry out the principles of the various described embodiments. It is understood by persons of skill in the art that one or more functional blocks may be optional in any particular implementation of the drone and that the functional blocks described in FIG. 4 are, optionally, combined or separated into sub-blocks to implement the principles of the various described embodiments. Therefore, the description herein optionally supports any possible combination or separation or further definition of the functional blocks described herein.

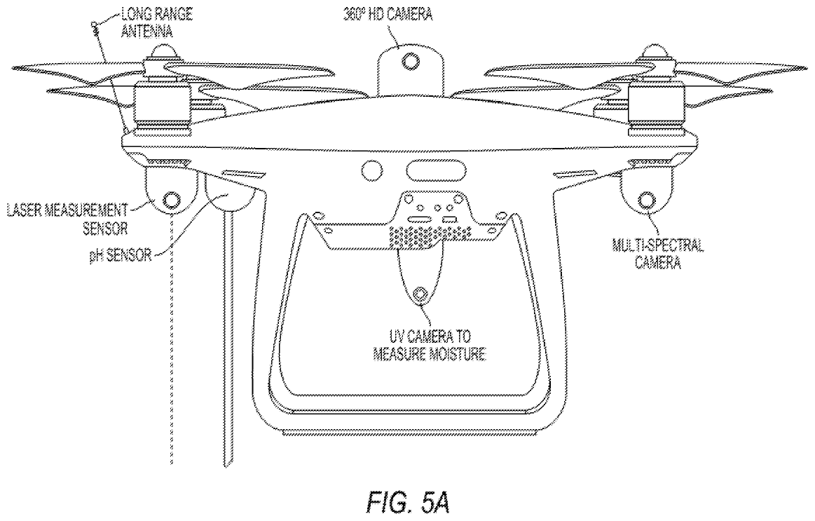

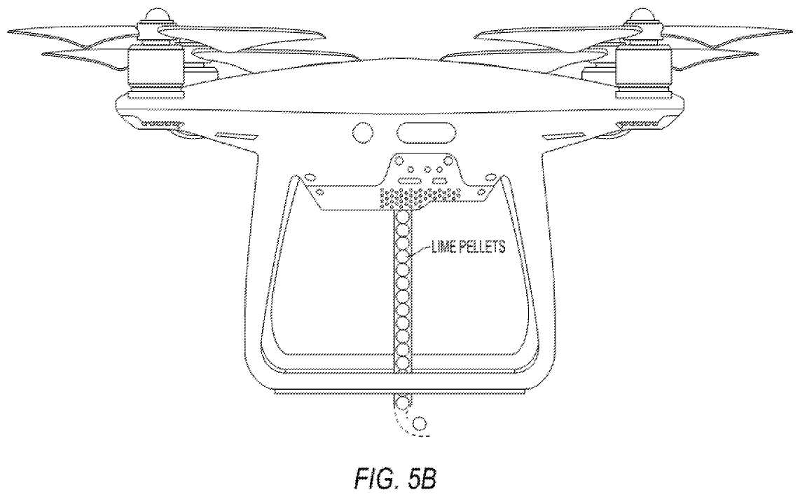

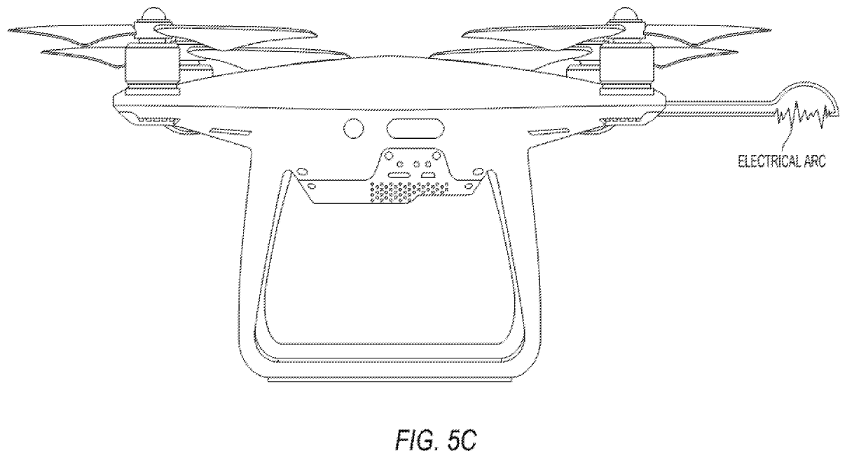

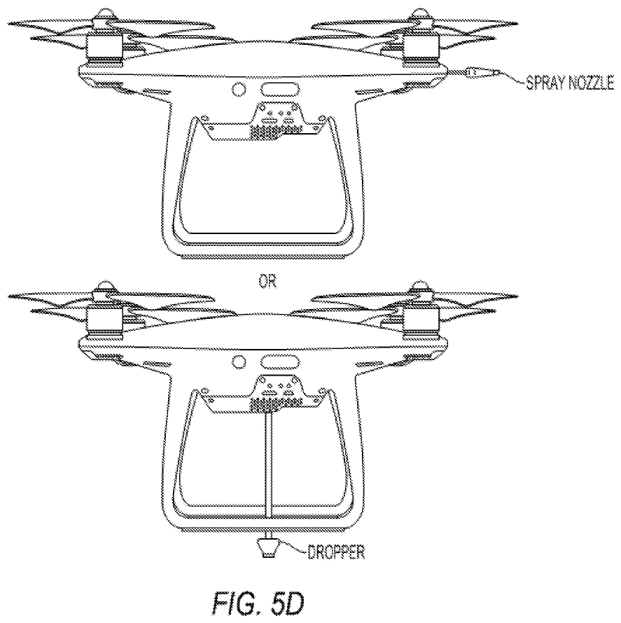

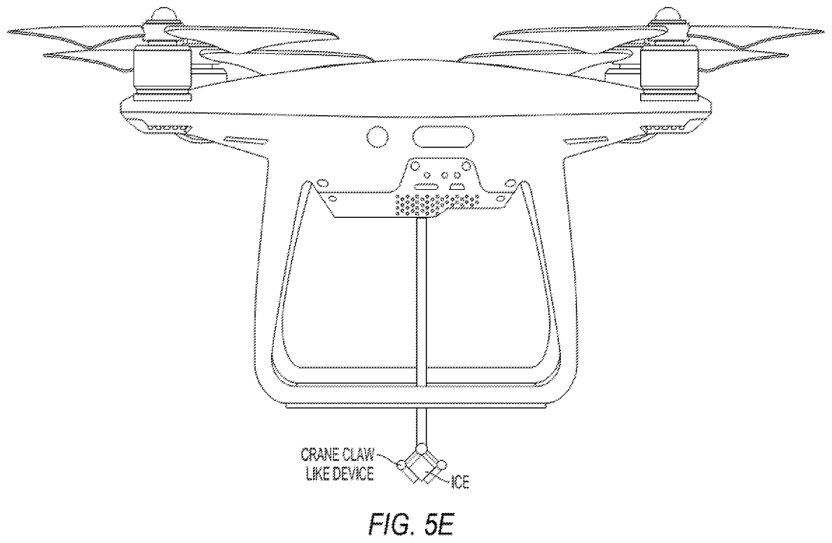

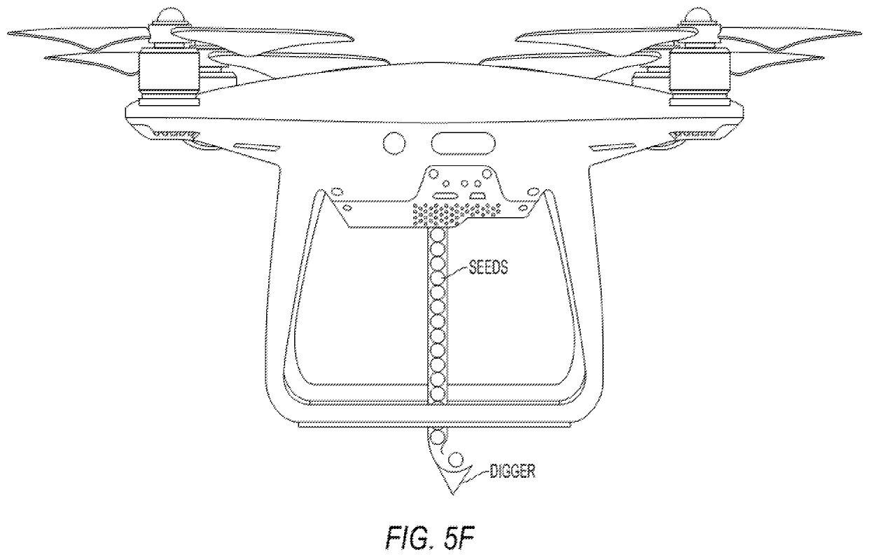

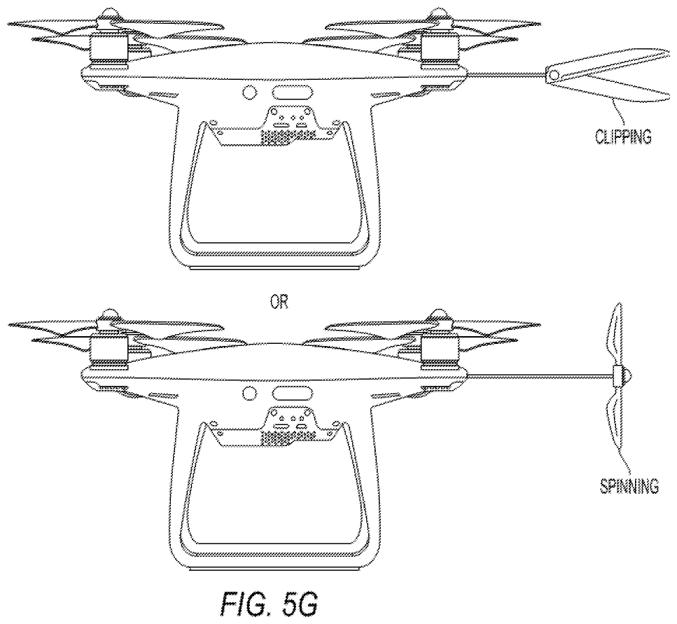

As shown in FIG. 4, a drone 400 includes: camera 402, sensor 404, GPS 406, carrier 408, propeller 410, cutter 412, digger 414, shock generator 416, scanner 418, networking device 422, dispenser 424, and rechargeable battery 426. The camera 402 may include one or more cameras for capturing images and recording videos, such as a 360 degree HD camera (e.g., depicted in FIG. 5A) and a multispectral camera (e.g., depicted in FIG. 5A). The sensor 404 may include one or more sensors for obtaining information of the plant and the surrounding environment, such as a pH sensor (e.g., depicted in FIG. 5A), a moisture sensor (e.g., depicted in FIG. 5A), a laser measurement sensor (e.g., depicted in FIG. 5A), and a UV camera for measuring moisture (e.g., depicted in FIG. 5A). The GPS 406 may include one or more GPS systems for obtaining location-based information. The carrier 408 may include one or more containers for carrying various substances for planting and growing the plant, such as water, fertilizer, pesticide, fungicide, ice, seed, and lime pellets (e.g., depicted in FIG. 5B). In some embodiments, a container may be refillable and may be designated to carry one particular type of substance, and not other types, to avoid cross-contamination. The propeller 410 may include one or more propellers for controlling the motion of the drone and, in some instances, for knocking off objects harmful to the health of the plant such as pests and broken limbs of the plant. The cutter 412 may include one or more mechanisms for cutting parts of the plant or knocking off harmful objects, such as a spinning blade or clipping blades (e.g., depicted in FIG. 5G). The digger 414 may include one or more diggers for planting seeds in the soil, such as the one depicted in FIG. 5F. The shock generator 416 may include one or more arc-generators for such as an electrical zapper (e.g., depicted in FIG. 5C). The scanner 418 may include one or more scanners for recognizing unique identifiers such as a bar code or a RFID chip. The networking device 422 may include one or more components for transmitting and receiving data (e.g., via wireless, cellular, or satellite networks), such as a long-range antenna (e.g., depicted in FIG. 5A). The dispenser 424 may include one or more devices for applying a proper amount of substance from the carriers to the desired area, such as a spray nozzle (e.g., depicted in FIG. 5D), a dropper (e.g., depicted in FIG. 5D), and a claw-like device (e.g., depicted in FIG. 5E). In some embodiments, a dispenser may be designated to dispense one particular type of substance, and not other types, to avoid cross-contamination. As discussed above, in some embodiments, the drone may, in the field or in the docking station, swap out any of the above-listed attachments with another attachment.

The drone 400 further includes processing unit 480 coupled to all of the above-listed attachments and, in some instances, configured to control one or more of the above-listed attachments. The processing unit 480 includes navigating unit 430, controlling unit 432, transmitting unit 434, receiving unit 436, and prescribing unit 438. One or more of the software units include AI algorithms and/or learning capabilities. Further, one or more of the software units (e.g., the navigating unit 430) implement swarm intelligence, as discussed above. As such, over time the drone can improve its performance in gathering data, analyzing data (e.g., recognizing parts of the plant and potential issues with the surrounding environment), and overall operation (e.g., navigating to the plant). As discussed above, the drone may, in the field or in the docking station, download and install software modules for controlling various hardware attachments and performing analysis.

In some embodiments, the size of the drone may vary based on the type of the plant. For example, because different plants are planted at different intervals, the size of the drone may vary based on the amount of space between the plants such that the drone is able to navigate to any part of the plant (e.g., top, bottom, among the leaves).

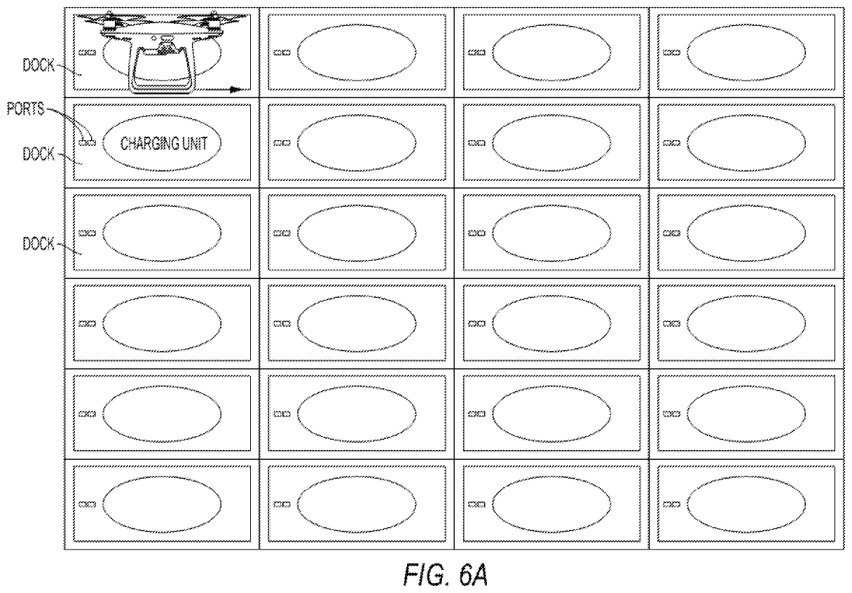

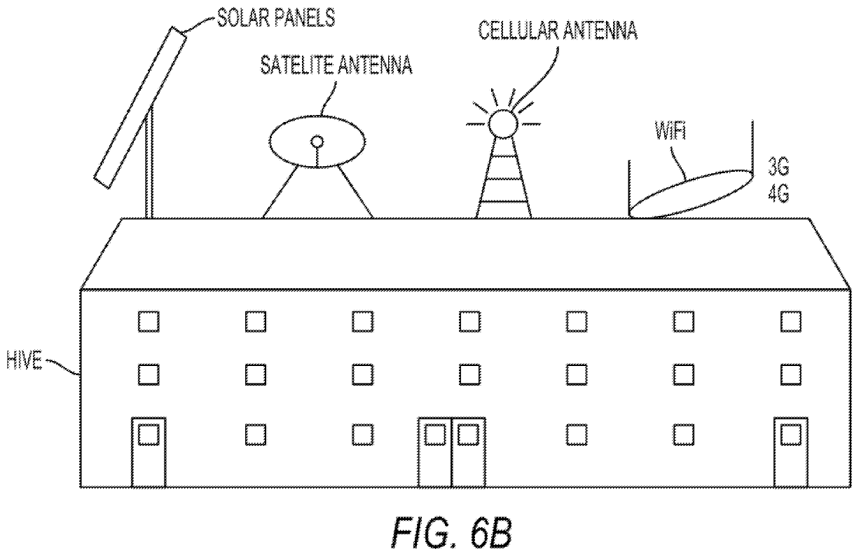

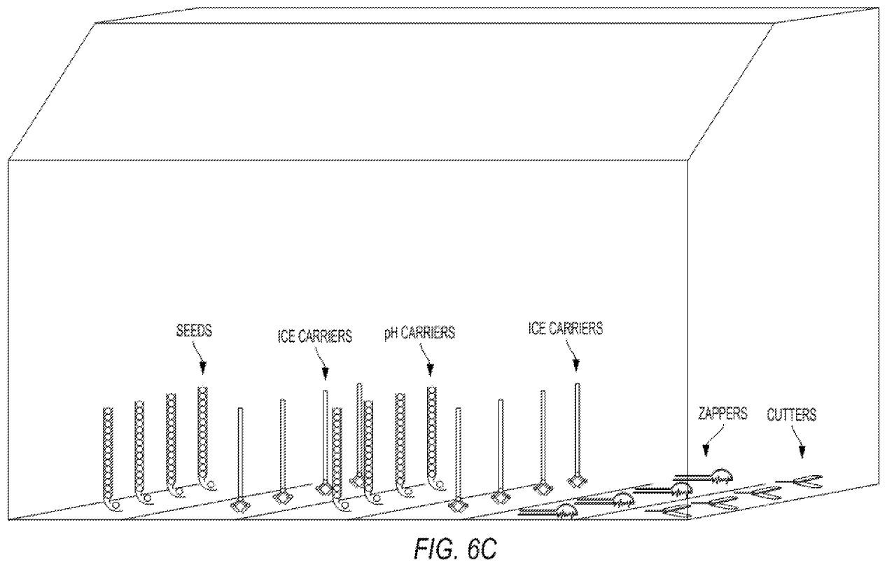

In accordance with some embodiments, FIG. 6A depicts an exemplary internal structure of a docking station configured in accordance with the principles of the various described embodiments, including those described with reference to FIGS. 1 and 2. The docking station may be centrally located relative to the fields. The docking station includes a plurality of docks, each of which can accommodate a drone. An exemplary dock includes a charging unit to allow a drone to recharge its battery. The dock also includes one or more data ports for transferring data from the drone to the docking station (e.g., sensor data, images, videos) and from the docking station to the drone (e.g., software updates, prescriptions, prescription requirements). The docking station also provides various supplies (fertilizer, water, ice, pesticide, insecticide, fungicide) and drone attachments (any of the drone attachments described in FIGS. 4 and 5A-G) so that the drone can equip itself accordingly for the next visit to the plant. The docking station may obtain electricity from solar energy, wind energy, the grid, or a combination thereof. As shown in FIG. 6B, the docking station may be equipped with a variety of networking devices for communicating with the drones and the server. In accordance with some embodiments, the docking may further include one or more processing units for analyzing the plant-specific data and formulating prescriptions.

FIG. 6C depicts a storage space for drone attachments and supplies. The storage space can store various supplies (fertilizer, water, ice, pesticide, insecticide, fungicide) and drone attachments (any of the drone attachments described in FIGS. 4 and 5A-G) so that the drone can configure itself accordingly. In some embodiments, the ice can be fortified with nutrition, pH, and other substances, thus solving multiple problems at the same time. In some embodiments, the various supplies and drone attachments are organized in a particular manner to facilitate identification and retrieval by the drone (e.g., in different rows, on different shelves). In some embodiments, the storage space is part of the docking station. In some embodiments, the storage space is external to the docking station. As discussed above, the drone may be assigned to perform various tasks for a single plant or be assigned to perform a single task for multiple plants. It should be appreciated that the location of the storage space can be set to allow for convenient configuration and re-configuration of the drones. For example, if the drones are assigned to perform various tasks for a single plant, the storage space may be located inside the docking station to allow for frequent reconfigurations between visits to the plant. As another example, if the drones are assigned to perform a single task for multiple plants, the storage space may be located external to the docking station so that initial configurations (e.g., installing spray nozzle and necessary software) can be performed at the storage space without interfering with the activities (e.g., charging, data transferring) at the docking station.

In accordance with some of the embodiments described herein, a single drone is assigned to manage one plant. This model may reduce the number of drones in the sky at any given time, thus reducing cost. It should be appreciated that one drone can manage multiple plants (e.g., multiple plants growing in the same row, on the same field, on the same farm), or multiple drones can manage a single plant (e.g., one drone assigned to water plants while another drone assigned to spray pesticide). It should be appreciated that, to achieve optimal operation, the system can allocate tasks across one or more drones, the server, and the docking station based on the computation resources required to analyze different issues and the different processing power of the various types of drones, the docking station, and the server.

In accordance with some embodiments, the server maintains a catalogue of each plant managed by the system. When a plant is created by the drone, a record of the plant is created on the server. The record includes a unique identifier of the plant, the location of the plant, the type of the plant, the type of the seed, and the time and date of planting the seed. As the drone makes regular visits to the plant, the server receives plant-specific data (e.g., from the drone directly or from the docking station). The record is updated based on the plant-specific data. The record can additionally include data that are not plant-specific, for example, the weather (e.g., amount of rainfall) and the information related to other farms. Accordingly, the server can track, among other things, nourishment provided, protection provided, and growth pattern over time on a per-plant basis. In some embodiments, the server includes one or more processing units that are capable of analyzing the data using AI algorithms By aggregating and analyzing the data stored on the server, the system can predict future issues (e.g., onset of disease) that may occur to a specific plant or to the entire farm and make adjustments to the management process to improve its effectiveness (e.g., via machine learning techniques).

Exemplary methods, non-transitory computer-readable storage media, systems, and electronic devices are set out in example implementations of the following items:

Item 1. A system for providing individualized management for a plurality of plants, the system comprising:

a docking station comprising a plurality of drone attachments;

a server including a database related to the plurality of plants, wherein the database includes location information associated with a first plant of the plurality of plants; and

a first drone assigned to the first plant, wherein the first drone is configured to accommodate a plurality of combinations of drone attachments and the first drone is configured to:
make a plurality of visits to the first plant,
gather plant-specific information associated with the first plant,
obtain a prescription based on the plant-specific information, wherein the prescription is associated with one or more requirements,
based on the prescription, provide care to the first plant.

Item 2. The system of item 1, wherein the plurality of drones includes a second drone assigned to a second plant of the plurality of plants.

Item 3. The system of any of items 1-2, wherein gathering plant-specific information associated with the first plant comprises capturing one or more images, by a camera of the first drone, of the first plant.

Item 4. The system of any of items 1-3, wherein the first drone is configured to transmit the gathered plant-specific information associated with the first plant to the server.

Item 5. The system of item 4, wherein the server is configured to: receive the gathered plant-specific information; and identify presence of weeds, pests, or diseases based on the plant-specific information.

Item 6. The system of any of items 4-5, wherein the server is configured to formulate the prescription based on the plant-specific information associated with the first plant.

Item 7. The system of item 6, wherein the prescription includes a procedure for protecting the first plant against weeds, diseases, or pests.

Item 8. The system of any of items 1-7, wherein the one or more requirements associated with the prescription specify one or more drone attachments, one or more supplies, or a combination thereof.

Item 9. The system of item 8, wherein the first drone is configured to: in response to obtaining the prescription, travel to the docking station; and based on the one or more requirements associated with the prescription, obtain the specified one or more drone attachments or one or more supplies from the docking station.

Item 10. The system of any of items 1-9, wherein the first drone is configured to accommodate: one or more cameras, one or more sensors, one or more GPS systems, one or more carriers, one or more propellers, one or more cutters, one or more diggers, one or more shock generators, one or more scanners, one or more networking devices, one or more dispensers, one or more batteries, or any combination thereof.

Item 11. The system of any of items 1-10, wherein the first drone is configured to carry: water, fertilizer, pesticide, fungicide, or any combination thereof.

Item 12. The system of any of items 1-11, wherein the first plant is planted by the first drone.

Item 13. The system of any of items 1-12, wherein the first drone is configured to: after gathering plant-specific information, travel to the docking station; and transfer the plant-specific information to the docking station.

Item 14. The system of any of items 1-13, wherein the server is configured to: update the database based on the gathered plant-specific information; and determine health condition of the first plant based on the gathered plant-specific information.

Item 15. A method for providing individualized management for a plurality of plants, the method comprising:

receiving plant-specific information associated with a first plant of the plurality of plants, wherein the plant-specific information is gathered by a first drone assigned to the first plant;
based on the plant-specific information, formulating a prescription, wherein the prescription is associated with one or more requirements;
based on the one or more requirements, equipping the first drone with a combination of drone attachments; and
using the first drone equipped with the combination of drone attachments, providing care to the first plant.

Item 16. The method of item 15, wherein the combination of drone attachments includes: one or more cameras, one or more sensors, one or more GPS systems, one or more carriers, one or more propellers, one or more cutters, one or more diggers, one or more shock generators, one or more scanners, one or more networking devices, one or more dispensers, one or more batteries, or any combination thereof.

Item 17. The method of any of items 15-16, wherein the prescription includes a procedure for protecting the first plant against weeds, diseases, or pests.

Item 18. The method of any of items 15-17, wherein equipping the first drone with the combination of drone attachments comprises: determining the combination of drone attachments based on the one or more requirements; and obtaining the combination of drone attachments from a docking station.

Item 19. The method of any of items 16-18, further comprising: after providing care to the plant, storing a record of the provided care in a database on a server.

Item 20. A drone comprising:

a memory;

one or more processors; and

one or more programs, wherein the one or more programs are stored in the memory and configured to be executed by the one or more processors, the one or more programs including instructions for:
making a plurality of visits to a plant assigned to the drone,
gathering plant-specific information associated with the plant,
obtaining a prescription, wherein the prescription is based on the plant-specific information and wherein the prescription is associated with one or more requirements, and
based on the prescription, providing care to the plant.

Item 21. The drone of item 20, wherein the one or more programs further include instructions for: after obtaining the prescription, obtaining a combination of drone attachments based on the one or more requirements.

Item 22. The drone of item 21, wherein the combination of drone attachments includes: one or more cameras, one or more sensors, one or more GPS systems, one or more carriers, one or more propellers, one or more cutters, one or more diggers, one or more shock generators, one or more scanners, one or more networking devices, one or more dispensers, one or more batteries, or any combination thereof.

Item 23. The drone of any of items 20-22, wherein the prescription includes a procedure for protecting the plant against weeds, diseases, or pests.

Item 24. The drone of any of items 20-23, wherein the one or more programs further include instructions for planting a seed corresponding to the plant.

Item 25. The drone of any of items 20-24, wherein obtaining the prescription includes: after gathering the plant-specific information, transmitting the plant-specific information to a server; receiving, from the server, the prescription.

Item 26. The drone of any of items 21-25, wherein obtaining the combination of drone attachments include traveling to a docking station.

Item 27. The drone of any of items 20-26, wherein the plant-specific information is a first set of plant-specific information, and wherein the one or more programs further include instructions for after providing care to the plant, gathering a second set of plant-specific information associated with the plant.

Item 28. The drone of any of items 20-27, wherein the one or more programs include instructions for initiating and completing one or more operations of the drone using artificial intelligence.

Item 29. The system of any of items 1-14, wherein the first drone is further configured to: receive an instruction for planting a seed, wherein the instruction indicates a location; and after receiving the instruction, deposit a seed at the indicated location, wherein the seed corresponds to the first plant.

Item 30. The system of item 29, wherein the location comprises an absolute location, a relative location, or a combination thereof.

Item 31. The system of item 29, wherein the instruction further indicates a type of seed.

Item 32. The system of any of items 1-14 and 29-31, wherein the database includes a planting time associated with the first plant.

Item 33. The system of any of items 1-14 and 29-32, wherein the first drone is configured to make the plurality of visits at a predetermined frequency.

Item 34. The system of item 33, where in the predetermined frequency is based on a type of the first plant.

Item 35. The system of any of items 1-14 and 29-34, wherein making a plurality of visits includes: determining a flight route to the first plant for a visit of the plurality of visits based on the location information associated with the first plant.

Item 36. The system of any of items 1-14 and 29-35, wherein making a plurality of visits includes: determining a flight route to the first plant for a visit of the plurality of visits based on one or more environmental factors.

Item 37. The system of any of items 1-14 and 29-36, wherein making a plurality of visits includes: determining a flight route to the first plant for a visit of the plurality of visits based on historical flight data.

Item 38. The system of any of items 1-14 and 29-37, wherein making a plurality of visits includes: determining whether the first drone is in proximity to the first plant based on identifying information associated with the first plant.

Item 39. The system of item 38, wherein the identifying information associated with the first plant includes a visual characteristic of the first plant.

Item 40. The system of item 38, wherein the identifying information associated with the first plant includes a bar code located on the first plant.

Item 41. The system of any of items 1-14 and 29-40, wherein the plant-specific information associated with the first plant includes a sample of the first plant.

Item 42. The system of any of items 1-14 and 29-41, wherein the plant-specific information associated with the first plant includes a sample of soil.

Item 43. The system of any of items 1-14 and 29-42, wherein the prescription includes a procedure for protecting the first plant against one or more weeds.

Item 44. The system of item 43, wherein the procedure includes cutting the one or more weeds.

Item 45. The system of item 43, wherein the procedure includes spraying chemicals onto the one or more weeds.

Item 46. The system of item 43, wherein the procedure includes providing electric shock to the one or more weeds.

Item 47. The system of item 43, wherein the procedure is determined based on a type of the one or more weeds, a size of the one or more weeds, proximity of the one or more weeds to the first plant, or any combination thereof.

Item 48. The system of any of items 1-14 and 29-47, wherein the prescription includes a procedure for protecting the first plant against a disease.

Item 49. The system of item 48, wherein the procedure includes cutting an infected portion of the first plant.

Item 50. The system of item 48, wherein the procedure includes applying chemicals onto the first plant.

Item 51. The system of item 48, wherein the procedure is determined based a type of the disease, a stage of the disease, or a combination thereof.

Item 52. The system of any of items 1-14 and 29-51, wherein the prescription includes a procedure for protecting the first plant against a pest.

Item 53. The system of item 52, wherein the procedure includes applying electric shock to the pest.

Item 54. The system of item 52, wherein the procedure includes knocking the pest off the first plant.

Item 55. The system of item 52, wherein the procedure includes applying pesticide onto the first pest.

Item 56. The system of item 52, wherein the procedure is determined based on a type of the pest, a size of the pest, proximity of the pest to the first plant, or any combination thereof.

Item 57. The system of any of items 1-14 and 29-56, wherein the docking station includes a plurality of charging ports.

Item 58. The system of any of items 1-14 and 29-57, wherein providing care to the first plant comprises conditioning soil around the first plant.

Item 59. The system of any of items 1-14 and 29-58, wherein the docking station is configured to store a plurality of supplies.

Item 60. The system of item 59, wherein the plurality of supplies includes fertilizer, water, ice, pesticide, insecticide, fungicide, or a combination thereof.

Item 61. The method of any of items 15-19, wherein the plant-specific information includes one or more images captured of the first plant, the method further comprising: determining a health condition of the first plant based on the one or more images.

Item 62. The method of item 61, wherein determining the health condition comprises identifying a presence of a weed, a pest, a broken limb, or a disease based on the one or more images.

Item 63. The method of any of items 15-19 and 61-62, further comprising predicting a health condition of the first plant based on the plant-specific information.

Item 64. The method of any of items 15-19 and 61-63, further comprising: after providing care to the first plant, updating a record associated with the first plant.

Item 65. The drone of any of items 20-28, further comprising one or more supplies, wherein providing care to the plant comprises deploying at least some of the one or more supplies to the plant.

Item 66. The drone of item 65, wherein the one or more supplies comprise water, fertilizer, pesticide, fungicide, or any combination thereof.

Item 67. The drone of any of items 20-28 and 65-66, wherein providing care to the plant comprises automatically downloading one or more software components based on the prescription.

The above description sets forth exemplary methods, parameters, and the like. It should be recognized, however, that such description is not intended as a limitation on the scope of the present disclosure but is instead provided as a description of exemplary embodiments.

Although the above description uses terms “first,” “second,” etc., to describe various elements, these elements should not be limited by the terms. These terms are only used to distinguish one element from another. For example, a first drone could be termed a second drone, and, similarly, a second drone could be termed a first drone, without departing from the scope of the various described embodiments. The first drone and the second drone are both drones, but they are not the same drone.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for providing individualized management for a plurality of plants, the system comprising:
a docking station comprising a plurality of drone attachments;
a server including a database related to the plurality of plants, wherein the database includes location information associated with a first plant of the plurality of plants; and
a first drone assigned to the first plant, wherein the first drone is configured to accommodate a plurality of combinations of drone attachments and the first drone is configured to:
make a plurality of visits to the first plant,
gather plant-specific information associated with the first plant,
obtain a prescription based on the plant-specific information, wherein the prescription is associated with one or more requirements,
based on the prescription, provide care to the first plant.

2. The system of claim 1, wherein the plurality of drones includes a second drone assigned to a second plant of the plurality of plants.

3. The system of claim 14, wherein gathering plant-specific information associated with the first plant comprises capturing one or more images, by a camera of the first drone, of the first plant.

4. The system of claim 1, wherein the first drone is configured to transmit the gathered plant-specific information associated with the first plant to the server.

5. The system of claim 4, wherein the server is configured to:
receive the gathered plant-specific information; and
identify presence of weeds, pests, or diseases based on the plant-specific information.

6. The system of claim 5, wherein the server is configured to formulate the prescription based on the plant-specific information associated with the first plant.

7. The system of claim 6, wherein the prescription includes a procedure for protecting the first plant against weeds, diseases, or pests.

8-14. (canceled)

15. A method for providing individualized management for a plurality of plants, the method comprising:
receiving plant-specific information associated with a first plant of the plurality of plants, wherein the plant-specific information is gathered by a first drone assigned to the first plant;
based on the plant-specific information, formulating a prescription, wherein the prescription is associated with one or more requirements;
based on the one or more requirements, equipping the first drone with a combination of drone attachments; and
using the first drone equipped with the combination of drone attachments, providing care to the first plant.

16. The method of claim 15, wherein the combination of drone attachments includes: one or more cameras, one or more sensors, one or more GPS systems, one or more carriers, one or more propellers, one or more cutters, one or more diggers, one or more shock generators, one or more scanners, one or more networking devices, one or more dispensers, one or more batteries, or any combination thereof.

17. The method of claim 16, wherein the prescription includes a procedure for protecting the first plant against weeds, diseases, or pests.

18-19. (canceled)

20. A drone comprising:
a memory;
one or more processors; and
one or more programs, wherein the one or more programs are stored in the memory and configured to be executed by the one or more processors, the one or more programs including instructions for:
making a plurality of visits to a plant assigned to the drone,
gathering plant-specific information associated with the plant,
obtaining a prescription, wherein the prescription is based on the plant-specific information and wherein the prescription is associated with one or more requirements, and based on the prescription, providing care to the plant.

21. The drone of claim 20, wherein the one or more programs further include instructions for:
after obtaining the prescription, obtaining a combination of drone attachments based on the one or more requirements.

22. The drone of claim 21, wherein the combination of drone attachments includes: one or more cameras, one or more sensors, one or more GPS systems, one or more carriers, one or more propellers, one or more cutters, one or more diggers, one or more shock generators, one or more scanners, one or more networking devices, one or more dispensers, one or more batteries, or any combination thereof.

23. The drone of claim 20, wherein the prescription includes a procedure for protecting the plant against weeds, diseases, or pests.

24. (canceled)

25. The drone of claim 20, wherein obtaining the prescription includes: after gathering the plant-specific information, transmitting the plant-specific information to a server;
receiving, from the server, the prescription.

26-67. (canceled)
